(19) United States
(12) Patent Application Publication
(10) Pub. No.: US 2007/0180968 A1
(43) Pub. Date: Aug. 9, 2007

(54) Cutter head for a meat cutter

(76) Inventors: Norbert Jacobi, Biedenkopf-Wallau (DE); Jurgen Bernhardt, Biedenkopf-Wallau (DE)

Correspondence Address: PERMAN & GREEN, 425 POST ROAD, FAIRFIELD, CT, 06824, US

(21) Appl. No.: 10/552,514

(22) PCT Filed: Mar. 31, 2004
(86) PCT No.: PCT/EP04/03413

§ 371 Date: Aug. 14, 2006

(30) Foreign Application Priority Data
Apr. 8, 2003 (DE) 103-16-303.4

(51) Int. Cl. B26D 1/12

(52) U.S. Cl. 83/666

(57) ABSTRACT

The invention relates to a cutter head disk for a meat cutter, on which at least one knife can be mounted by means of eccentric bolts and optional magnets and which is provided with a metallic core for accommodating the drive shaft. Preferably, the core comprises a plastic envelope. The invention further relates to a knife having a geometry that is provided with a great axial load-bearing capability. Also disclosed are a system comprising a cutter head disk and two knives, a cutter head encompassing several systems, and a method for assembling a cutter head.

The present invention relates to a cutter head disk for a meat cutter, on which at least one knife can be mounted and which has a preferably metallic core for accommodating the drive shaft. The present invention furthermore relates to a system comprising a cutter head disk and two knives and a cutter head comprising a plurality of systems and a method for installation of a cutter head.

Cutter heads of the generic type are known from the prior art. However, these cutter heads have the disadvantage that they can be fitted only with comparative complexity because the cutter head disks can generally only be fitted on the cutter shaft together with the knives. Furthermore, the cutter heads are comparatively unhygienic because the material to be cut can collect within the cutter head disk and between the cutter head disk and the knives fitted on it.

The present invention is therefore based on the object of providing a cutter head disk for a meat cutter which does not have the disadvantages of the prior art.

The object is achieved by a cutter head disk for a meat cutter, on which at least one knife can be mounted and which has a preferably metallic core for accommodating the drive shaft and in which the core is surrounded, preferably encapsulated by casting, by an envelope.

The envelope is preferably composed of plastic. This embodiment of the present invention has the advantage that the cutter head disk has a comparatively low weight, which is a positive attribute during transportation, during installation and at high rotational speeds. Furthermore, plastic envelopes are comparatively elastic, with the result that the cutter head disks and the associated knives can readily be fixed against one another.

“Surrounds” within the meaning of the invention signifies a frictional and/or interlocking bond between the core and the envelope, with the result that cut material cannot pass between the core and the envelope.

The core preferably has recesses in which in each case at least one eccentric retaining bolt for the knife can be mounted.

The object is furthermore achieved by a cutter head disk for a meat cutter, on which at least one knife can be mounted and which has recesses in which in each case one eccentric retaining bolt for the knife can be mounted. The eccentric retaining bolts are preferably preassembled on the cutter head disk before the cutter head disk is fitted on the cutter head shaft.

The following details apply to all of the subject matters of the present invention.

The cutter head disk preferably has magnets at which the knives can be fixed to the cutter head disk.

In a further preferred embodiment, the cutter head disk according to the invention has a sealing edge, preferably on both sides of the disk. This sealing edge is preferably designed as a raised circular ring.

The cutter head disk according to the invention furthermore preferably has recesses into which, for example, weights for counterbalancing the disk together with knives can be fitted.

In a further preferred embodiment, the cutter head disk has shoulders between which the base of the knife can be mounted. The height of the shoulders is preferably essentially the same as or somewhat smaller than the thickness of the base of the knife and the distance between the shoulders particularly preferably corresponds essentially to the width of the base of the knife.

The cutter head disk according to the invention has the advantage that no cutting material can penetrate between the preferably metallic core and the plastic envelope. Furthermore, no cutting material penetrates through the sealing edge between the cutter head disk and the knives fitted thereon, which likewise constitutes a considerable hygienic advantage. The cutter head disk according to the invention can initially be fitted on the cutter head shaft without knives. Only then are the knives fitted on the cutter head disk and held on the cutter head disk by the magnets before the cutter head disk together with knives is fixed on the shaft, for example with a clamping nut, which constitutes a considerable facilitation of installation. The transportation of cutter disk together with knives is considerably simplified with the cutter head disk according to the invention because the knives and the cutter head disk are easy to remove and accordingly can be transported separately from one another.

The cutter head disk according to the invention can be produced in a simple and cost-effective manner.

The present invention furthermore relates to a knife in which the ratio of clamping radius B to knife radius A is 0.3 to 0.4, preferably 0.37 to 0.38. Furthermore, a knife is claimed in which the ratio of knife radius A to receiving width C is 1.4 to 2.0, preferably 1.6 to 1.7. This knife preferably has the ratio according to the invention of B to A. This preferred embodiment of the system according to the invention has the advantage that the knives withstand relatively high axial loads.

The present invention furthermore relates to a system comprising a cutter head disk and two knives which in each case have two recesses, preferably holes, with the eccentric bolts being introduced into the hole.

A further aspect of the present invention is a system comprising the cutter head disk according to the invention, a knife and a filling plate, the knife and the filling plate in each case having two recesses, preferably holes, through which eccentric bolts are introduced.

The filling plate is preferably preassembled on the cutter head disk before the cutter head disk is fitted on the cutter head shaft.

In a preferred embodiment of the system according to the invention, the filling plate has recesses through which the dynamic unbalance can be compensated for.

In a further preferred embodiment of the system according to the invention, the knives and/or the filling plate are to be reversibly fastened to the cutter head disk with the magnets. This embodiment of the present invention has the advantage that the cutter head disk can be mounted on the cutter head shaft without the knives and the knives can then be fitted by the recesses of the knives being guided over the eccentric bolts and a releasable frictional connection between the metallic knife and the magnets being formed.

The cutter head disk and the knives fitted thereon are preferably designed in such a manner that the ratio of clamping radius B to knife radius A is 0.3 to 0.4, preferably 0.37 to 0.38. Furthermore, the ratio of knife radius A to receiving width C is preferably 1.4 to 2.0, with preference 1.6 to 1.7. This preferred embodiment of the system according to the invention has the advantage that the knives withstand relatively high axial loads and the cutter head disk is not of such a large design that the volumetric flow of the cut material is obstructed.

The system according to the invention has the advantage that no cutting material can penetrate between the metallic core and the envelope. Furthermore, no cutting material penetrates through the sealing edge between the cutter head disk and the knives fitted thereon, which likewise constitutes a considerable hygienic advantage.

The present invention furthermore relates to a cutter head which has a plurality of systems according to the invention. These systems are arranged one behind another on a cutter head shaft and are fixed on the cutter head shaft by a clamping nut.

The cutter head according to the invention is suitable in particular for a very high rotational speed of the knife tip, preferably >approx. 145 m/sec. The dynamic unbalance is compensated for in the region of the cutter head disks; i.e. in the knife plane. All of the knives of the cutter head are identical in length and can accordingly be arranged on any desired cutter head disk within the cutter head. The knives do not have to be assigned to a certain meat cutter, which considerably simplifies the logistics of the knives. A malfunction of the cutter head due to defective balancing is avoided. The cutter head according to the invention is fully self-contained, so that no cut material can accumulate between the individual cutter head disks. The cleaning of the cutter head according to the invention can take place after release of the clamping nut without using a tool. A static or dynamic balancing of the cutter head according to the invention generally does not take place.

The present invention furthermore relates to a method for installing a cutter head according to the invention, in which the cutter head disk is fastened to the shaft and the knives and/or a knife and a filling plate are then mounted on the cutter head disk.

The cutter head is preferably then fixed on the shaft by a clamping screw.

Furthermore, the cutter head disks and the knives and filling plates can be preassembled on a sleeve which is then mounted on the cutter head shaft.

The method according to the invention can be carried out very simply and in a very cost-saving and harmless manner for the installer, since first of all the cutter head disk can be fitted on the cutter head shaft and then the knives can be fitted to the cutter head disk. The next cutter head disk is then installed. After all of the cutter head disks and knives are installed, these have merely to be fixed on the cutter head shaft preferably by a clamping nut. For removal, first of all the knives are removed from a cutter head disk and then this cutter head disk is removed from the shaft. Every knife can be combined with every cutter head disk, which considerably simplifies the installation and the logistics of the knives. The same knife may even be used in different meat cutters.

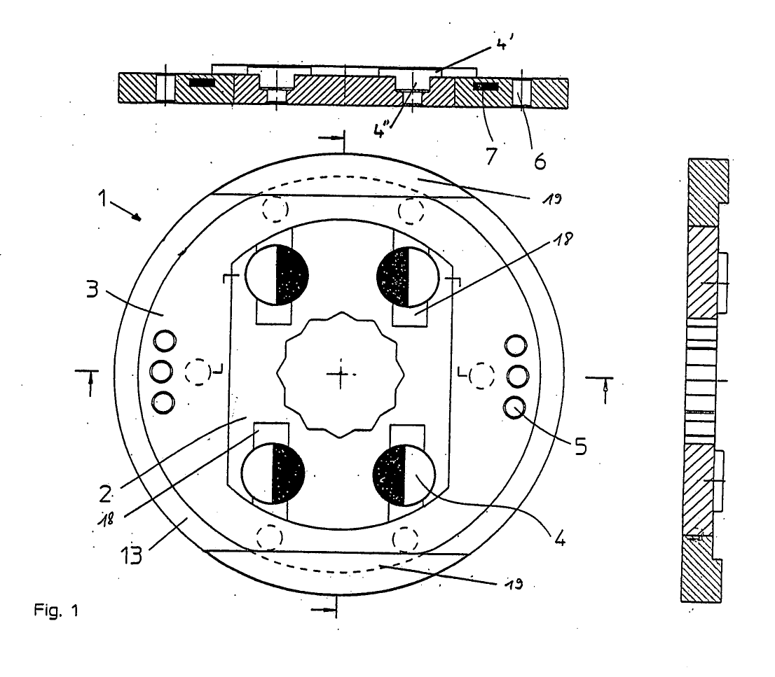

The invention is explained below with reference to FIGS. 1 to 10. These explanations are merely by way of example and do not restrict the general concept of the invention.

FIG. 1 shows an embodiment of the cutter head disk according to the invention.

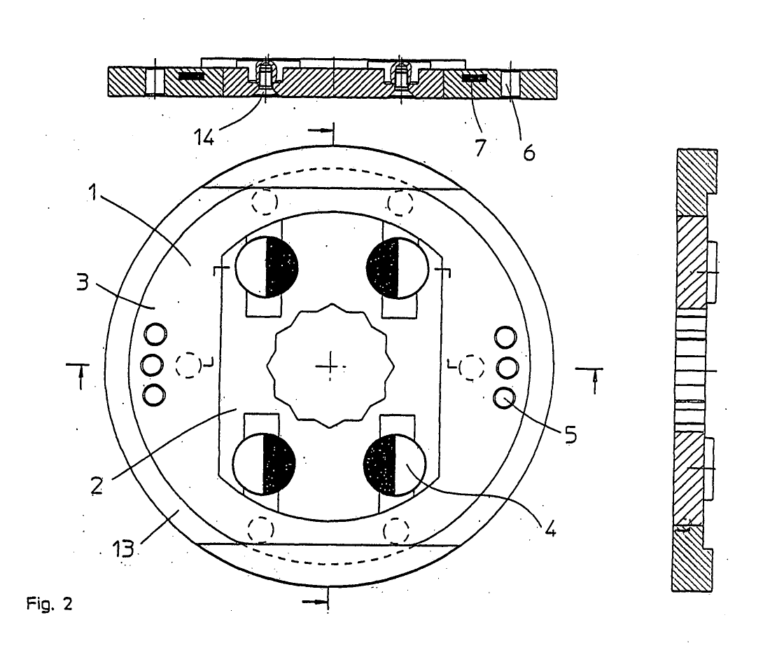

FIG. 2 shows a further embodiment of the cutter head disk according to the invention.

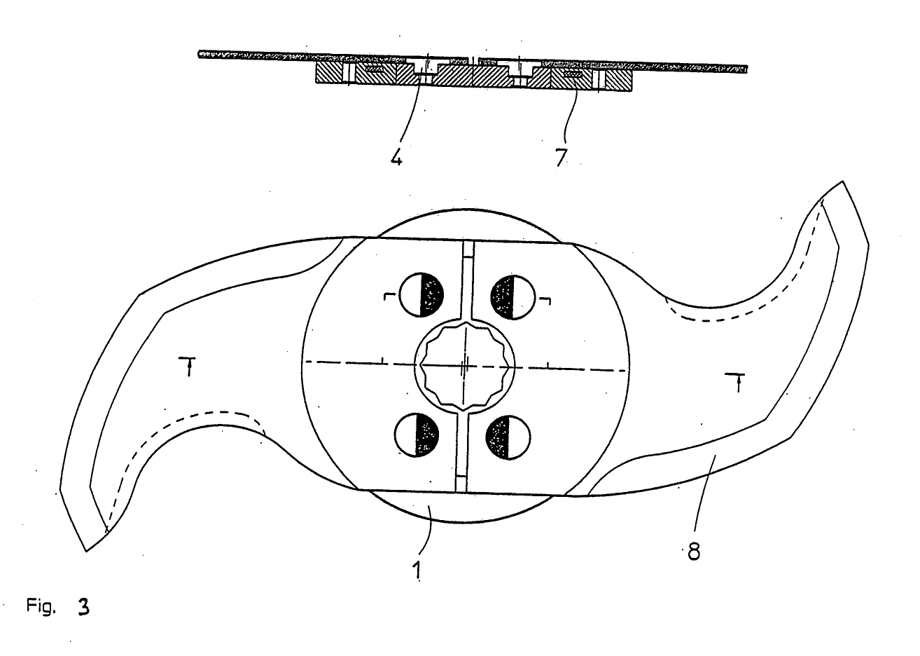

FIG. 3 shows the system according to the invention with one position of the eccentric retaining bolts.

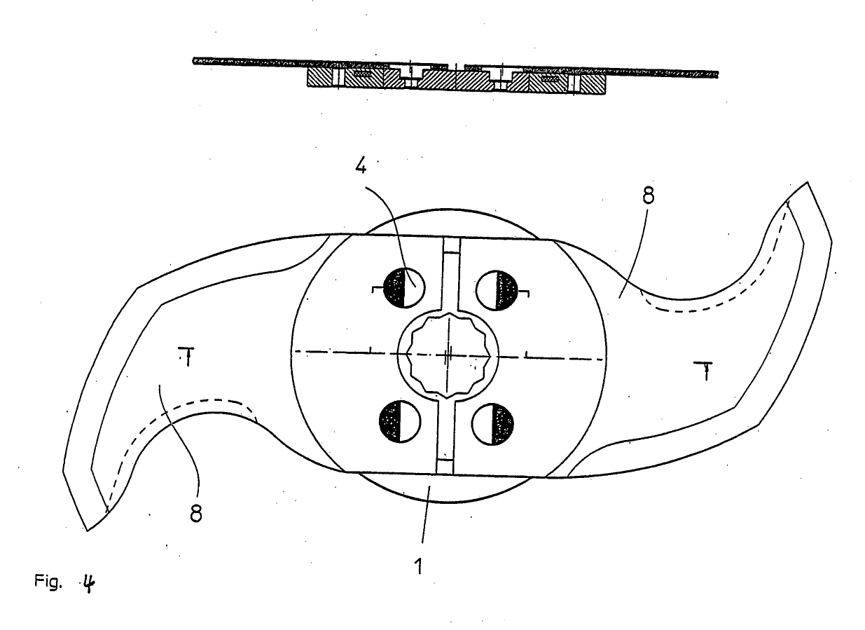

FIG. 4 shows the system according to the invention with a different position of the eccentric retaining bolts.

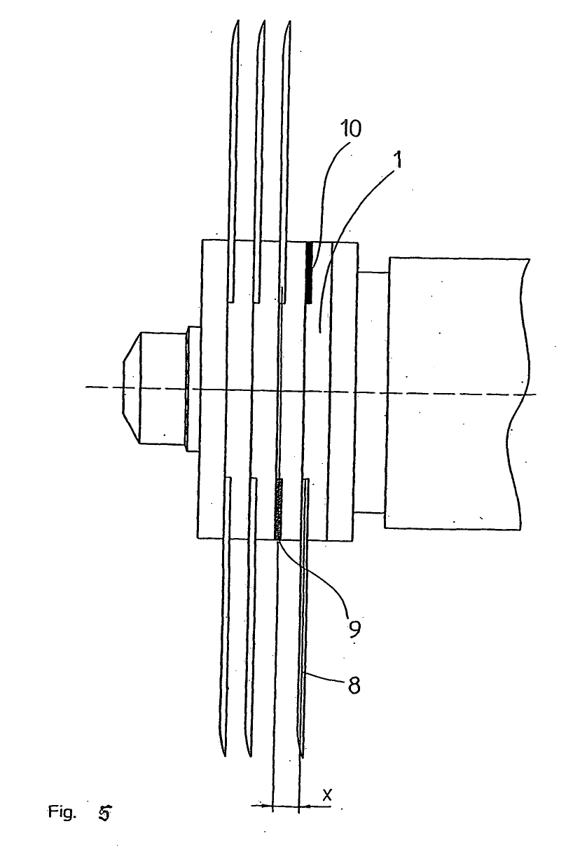

FIG. 5 shows the cutter head according to the invention.

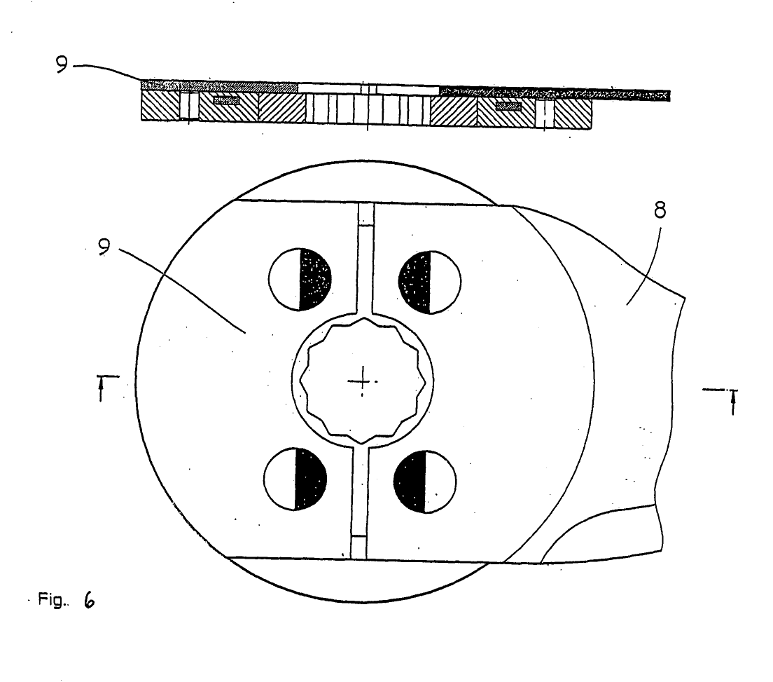

FIG. 6 shows the system according to the invention with a filling plate.

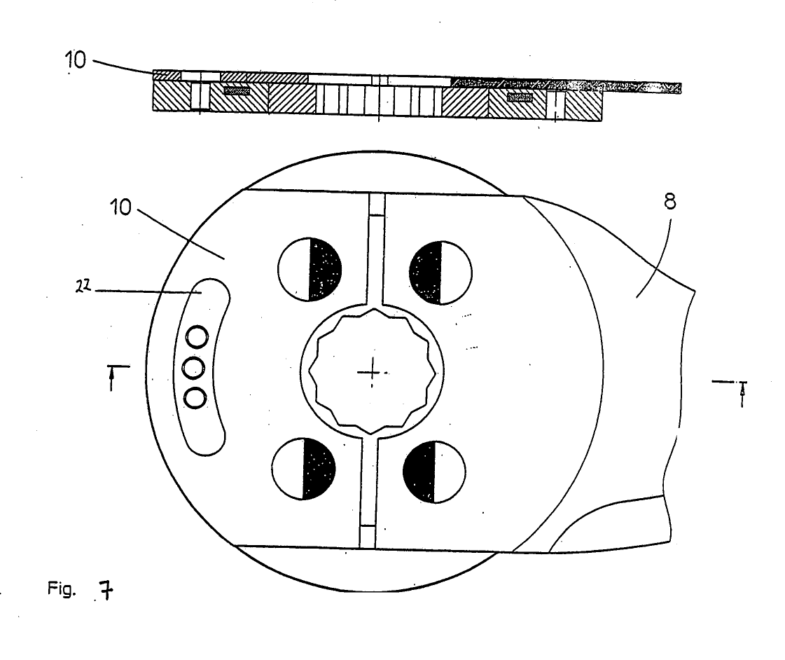

FIG. 7 shows a further embodiment of the system according to the invention with a filling plate.

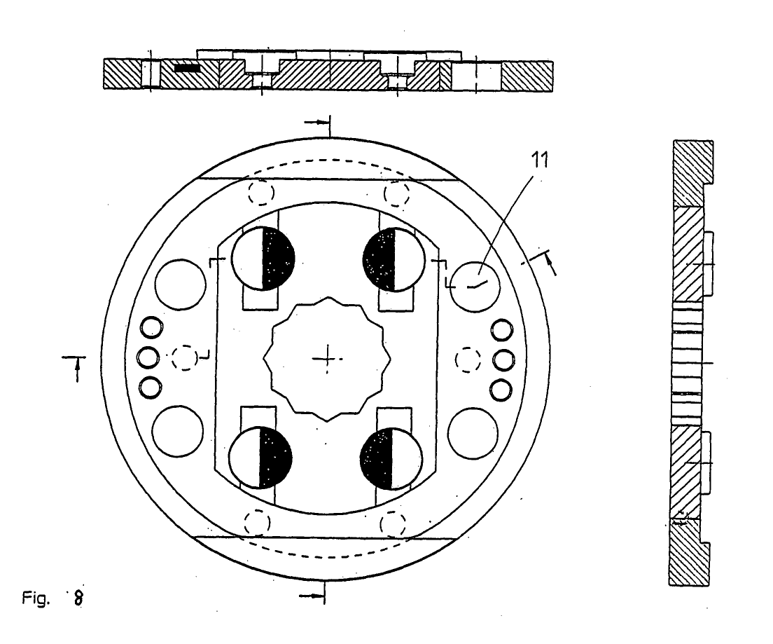

FIG. 8 shows a further embodiment of the cutter head disk according to the invention.

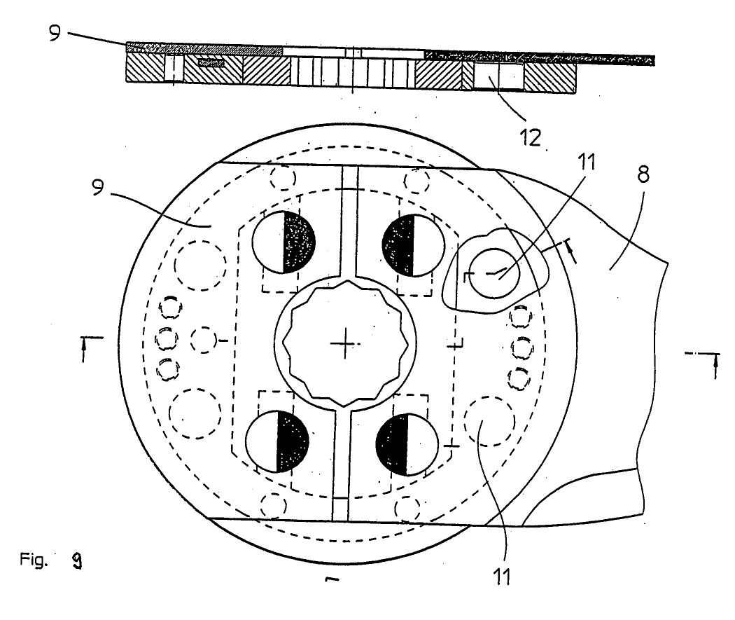

FIG. 9 shows a further embodiment of the system according to the invention with a filling plate.

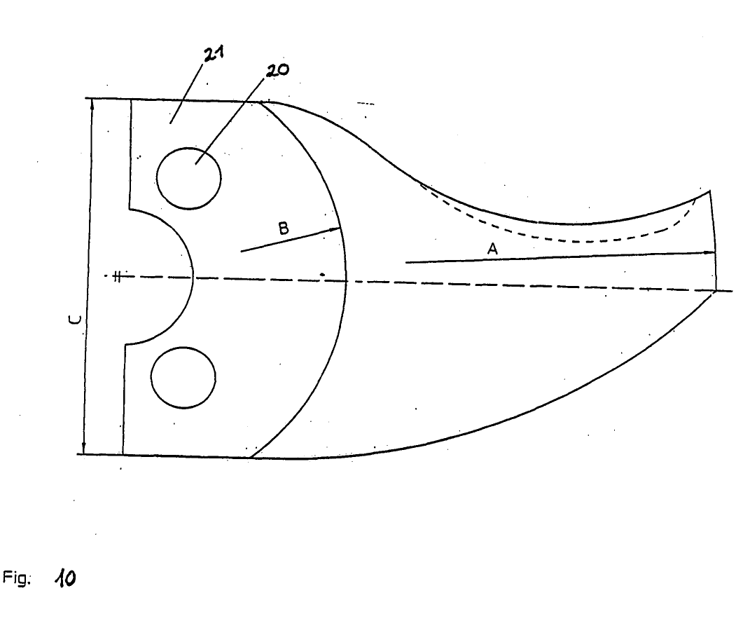

FIG. 10 shows a knife which can be mounted on the cutter head disk according to the invention.

FIG. 1 shows an embodiment of the cutter head disk 1 according to the invention which comprises a metallic core 2 and a plastic envelope 3. According to the invention, the core 2 is encapsulated with the plastic envelope 3 by casting, so that there is an interlocking and/or frictional bond between the two parts without further aids and material cannot collect between the metallic core and the plastic envelope. The outside of the metallic core preferably has means, for example a ribbing, which improves the bond between the core 2 and the plastic envelope. A preferably 12-edged receptacle for the drive shaft of the cutter head is arranged in the metallic core. Also provided in the metallic core are recesses 18 which can in each case accommodate an eccentric retaining bolt with which the knives (not illustrated) can be mounted on the cutter head disk. In the present case, the eccentric retaining bolts 4 are inserted into the recesses 18. The eccentric retaining bolts 4 have a circular, disk-shaped head 4′ which is arranged eccentrically on its base 4″, where the areas shown in black protrude further out of the center than the areas shown in white. This eccentricity permits the knife (not illustrated) to be arranged in two different positions on the cutter head disk by means of a bolt. A cutter head disk is supplied as a set with a plurality of eccentric retaining bolts which differ, however, only in the degree of their eccentricity. The head 4′ and the base 4″ are in each case identical. The person skilled in the art recognizes that the eccentric bolts may also have different shapes. For example, eccentric bolts with more than two adjustments are conceivable, in which case the cutter head disk here must not have any shoulders.

Permanent magnets 7 with which the knives can be fixed on the cutter head disk are embedded in the plastic envelope 3, which can be seen, for example, in FIG. 3 or 4. Furthermore, the plastic envelope has recesses 5 into which, for example, weights can be inserted in order to be able to compensate for unbalances, for example differences in weight of knives. The sealing edge 13 interacts with the knives (not illustrated) fitted on it and has the effect that no cut material passes between the knife and the cutter head disk. The person skilled in the art recognizes that a sealing edge of this type can also be arranged on the other side of the cutter head disk. Furthermore, the cutter head disk according to the invention has shoulders 19 between which the base of the knife is arranged. The height of the shoulders and the thickness of the base of the knife should as far as possible be the same or differ merely by the particular degree of tolerance. The distance between the shoulders corresponds essentially to the width of the base of the knife.

In FIG. 2, essentially, the cutter head disk according to FIG. 1 is illustrated, but in the present case the eccentric retaining bolts 4 are not inserted into the recesses 18, but are fastened by means of screws 14. The person skilled in the art recognizes that further fastenings are conceivable.

FIG. 3 shows the system according to the invention comprising a cutter head disk 1 and two knives 8. The eccentric retaining bolts are positioned inward with their wide side, which is illustrated in black, so that the radial extent of the system is as small as possible. This is the typical position of the eccentric retaining bolts 4 with knives 8, the outer radius of which has not yet been reduced by being worn down.

FIG. 4 shows a system according to the invention, in which the eccentric retaining bolts are arranged on the cutter head disk in such a manner that their wide sides (illustrated in black) are directed outward, so that in the present case the radial extent of the knife is as large as possible. This position is selected, for example, if, after grinding, the radial extent of the knife has been reduced to such an extent that the distance between cutter edge and the bowl of the cutter in which the knife rotates has become too large, although occurs only when the knife is damaged. The person skilled in the art recognizes that a system is supplied with a plurality of eccentric retaining bolts which differ merely with regard to their degree of eccentricity, so that the radial extent of the system can be set with very great precision. It is possible, for example, to position all of the knives at a defined distance from the bowl.

FIG. 5 shows a variant of the cutter head according to the invention which, in the present case, comprises four cutter head disks according to the invention, of which two are fitted in each case with two knives 8 on a running plane and two are fitted in each case with a knife and a filling plate 9, 10 on different running planes. The knives together with cutter head disk are fixed on the drive shaft of the cutter head by means of a clamping nut. Details of the filling plates 9, 10 can be gathered from FIGS. 6, 7. The knives 8 may be arranged on any desired running planes.

FIG. 6 shows a system according to the invention with a filling plate which is preassembled on the cutter head disk before the latter is mounted on the cutter head shaft. In the same manner as the knife 8, the filling plate 9 has recesses with which they are placed onto the eccentric retaining bolts. The magnets 7 prevent the filling plate, in the fitted state and before the cutter head is fixed in place, from tipping forward from the cutter head disk. The filling plate may also be changed in its radial position by the eccentric retaining bolts 4. In the same manner as the knives 8, the filling plate 9 also interacts with the sealing edge 13, so that no cutting material passes between the filling plate 9 and the cutter head disk where it is responsible for insufficient hygiene or corrosion.

FIG. 7 shows a further embodiment of the system according to the invention with a filling plate 10. In the present case, the filling plate has a recess 22 which serves to compensate for a dynamic unbalance. The person skilled in the art recognizes that the recess 22 can have any desired shape. Below the recesses 22, recesses 5 can be seen in the plastic envelope 3 of the cutter head disk 1.

FIG. 8 shows a further refinement of the cutter head disk according to the invention which essentially corresponds to the cutter head disk according to FIG. 1 but the present cutter head disk has recesses 11. These recesses can likewise be used to compensate for dynamic unbalances. Furthermore, these recesses, as illustrated in FIG. 9, can be filled with weights 12 in order even better to be able to compensate for dynamic unbalances.

FIG. 10 shows a knife which can be combined, for example, with the cutter head disk. The knife has in its base 21 with a possible shape of the recesses 20 which can be placed onto the eccentric retaining bolts. Furthermore, the ratio of the clamping radius B to the knife radius A in the present case is 0.35 and the ratio of the knife radius A to the receiving width C is 1.65. This knife can absorb very high axial loads without the flow of material into the plane of the paper being obstructed by the cutter head disk.

### LIST OF REFERENCE NUMBERS

1 Cutter head disk with metallic core and plastic envelope

2 Cutter head disk with 12-edged receptacle for the drive shaft and eccentric retaining bolts for the fastening of the knives

3 Plastic envelope for the installation and clamping of the knives

4 Eccentric retaining bolts for the knives

5 Receiving hole for counterbalancing the knives

6 Compensating weight

7 Permanent magnet

8 Knife

9 Filling plate

10 Filling plate with cutout

11 Receiving bore for compensating weight

12 Compensating weight with knife construction on two levels

13 Sealing edge

14 Fastening screw

18 Recess

19 Shoulder

22 Cutout

1. A cutter head disk (1) for a meat cutter, on which at least one knife (8) can be mounted and which has a preferably metallic core (2) for accommodating the drive shaft, characterized in that the core (2) is surrounded, preferably encapsulated by casting, with an envelope (3), preferably a plastic envelope so that the core (2) is connected in a frictional and/or interlocking manner with the envelope (3).

2. The cutter head disk as claimed in claim 1, characterized in that the core (2) has at least one recess (18) in which in each case at least one eccentric retaining bolt (4) for the knife (8) can be mounted.

3. A cutter head disk (1) for a meat cutter, on which at least one knife (8) can be mounted, it having at least one recess (18) in which in each case at least one eccentric retaining bolt (4) for the knife (8) can be mounted, characterized in that the knife (8) can be arranged in at least two different positions on the cutter head disk (1) by means of the eccentric retaining bolt (4).

4. The cutter head disk as claimed in claim 1, characterized in that it has magnets (7) with which the knife (8) can be fixed on the cutter head disk (1).

5. The cutter head disk as claimed in claim 1, characterized in that it has at least one sealing edge (13).

6. The cutter head disk as claimed in claim 5, characterized in that the sealing edge (13) is designed as a raised circular ring or section.

7. The cutter head disk as claimed in claim 1, characterized in that it has recesses (5, 11).

8. The cutter head disk as claimed in claim 7, characterized in that weights (6, 12) can be fitted into the recesses (5, 11).

9. The cutter head disk as claimed in claim 1, characterized in that it has shoulders (19), the height of which is essentially the same as or somewhat smaller than the thickness of the base (21) of the knife (8) and the distance between which essentially corresponds to the width of the base of the knife.

10. A knife, characterized in that the ratio of clamping radius B to knife radius A is 0.3-0.4, preferably 0.37-0.38.

11. The knife, in particular as claimed in claim 10, characterized in that the ratio of knife radius A to receiving width C is 1.4-2.0, preferably 1.6-1.7.

12. A system comprising a cutter head disk as claimed in claim 1 and two knives (8) which in each case have two recesses (20), preferably holes, characterized in that the eccentric retaining bolts (4) are introduced into the holes (20).

13. A system comprising a cutter head disk as claimed in claim 1 and a knife (8) and a filling plate (9, 10) which in each case has two recesses (20), preferably holes, characterized in that the eccentric retaining bolts (4) are introduced into the holes (20).

14. The system as claimed in claim 13, characterized in that the filling plate has recesses (22).

15. The system as claimed in claim 12, characterized in that the knives (8) and/or filling plates (9, 10) can be reversibly fastened to the cutter head disk (1) with the magnets (7).

16. The system, preferably as claimed in claim 12, characterized in that the ratio of clamping radius B to knife radius A is 0.3-0.4, preferably 0.37-0.38.

17. The system, as claimed in claim 12, characterized in that the ratio of knife radius A to receiving width C is 1.4-2.0, preferably 1.6-1.7.

18. A cutter head, having at least one system as claimed in claim 9, characterized in that it is arranged on a shaft.

19. The cutter head as claimed in claim 18, characterized in that the dynamic unbalance is compensated for in the knife plane.

20. The cutter head as claimed in claim 18, characterized in that it does not have to be balanced.

21. The cutter head as claimed in claim 18, characterized in that all of the knives are of equal length.

22. The cutter head as claimed in claim 18, characterized in that it is closed to the outside and is smooth apart from the protruding knives.

23. A method for installation of a cutter head as claimed in claim 18, characterized in that the cutter head disk (1) is fastened to the shaft and the knives (8) and/or a knife (8) and a filling plate (9) are then mounted on the cutter head disk (1).

24. The method as claimed in claim 23, characterized in that the cutter head is fixed on the shaft.

25. A method for installation of a cutter head as claimed in claim 18, characterized in that the cutter head disks (1) and the knives (8) and filling plates (9, 10) are preassembled on a sleeve which is then mounted on the cutter head shaft.

26. The method as claimed in claim 23, characterized in that every knife can be combined with every cutter head disk.
